(19) United States
(12) Patent Application Publication
(10) Pub. No.: US 2016/0268707 A1
(43) Pub. Date: Sep. 15, 2016

(54) Female contact comprising a spring

(71) Applicant: SOCIETE TECHNIQUE DE PRODUCTIONS INDUSTRIELLES, PARIS (FR)

(72) Inventors: Michel NESPOULOUS, HAUPPAUGE, NY (US); Christophe BOUCHER, PARIS (FR); Pascal CUIROT, PARIS (FR)

(21) Appl. No.: 15/065,918

(22) Filed: Mar. 10, 2016

(30) Foreign Application Priority Data
Mar. 13, 2015 (FR) 15 52068

(51) Int. Cl. H01R 4/48; H01R 13/03; H01R 43/20; H01R 13/187

(52) U.S. Cl. CPC H01R 4/48; H01R 13/187; H01R 13/03; H01R 43/20

(57) ABSTRACT

A female contact intended to receive a male contact, the female contact including a base and at least one side wall having a free edge defining an open end, the side wall being connected to the base and including an inner wall, wherein: the female contact includes a helical spring made of an electrically conductive material disposed between the base and the open end; part of the inner wall and the base are made of an electrically conductive material; and the inner wall of the female contact and/or the spring assure/assures electrical contact with a male contact in the position of use.

The present invention relates to a female contact intended to receive a male contact. More particularly, the invention relates to a female contact comprising a spring intended to establish electrical contact between said female contact and a male contact.

The present invention also relates to a method for modifying an existing female connector.

A female connector is a device comprising at least one female contact in which a male connector comprising at least one male contact is inserted in order to establish electrical contact. The electrical contact is established when the female contact is in contact with the male contact.

It is therefore essential that the contact between the female contact and the male contact does not have any faults, so that electrical contact can be established continuously.

This type of connection exists in a very large number of electrical devices including, for example, electrical relays and baseplates thereof.

Electrical relays and baseplates thereof are thus formed of a female connector (referred to as a baseplate) comprising at least one female contact (referred to as a socket) into which a male connector (referred to as a relay) comprising at least one male contact is inserted.

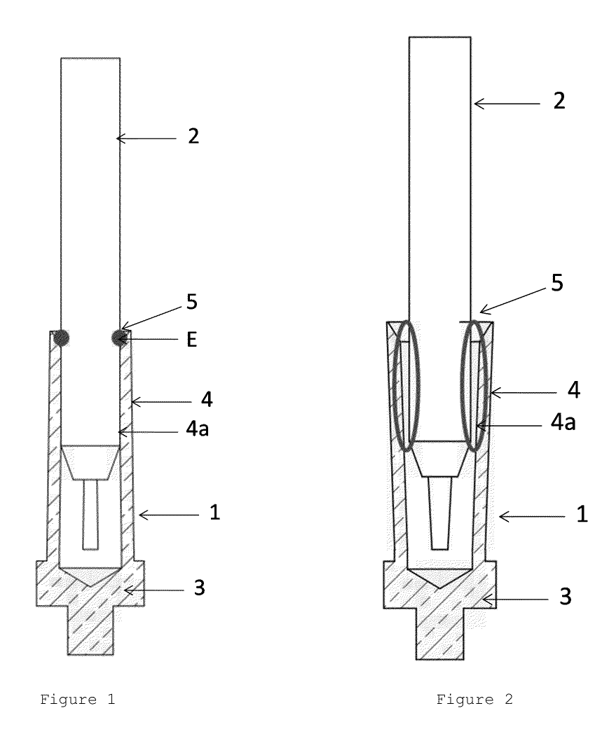

FIG. 1 illustrates the points of electrical contact between a female contact and a male contact in a conventional connection. This electrical contact is produced at the inner wall of the side wall of the female contact.

However, when these connections are used in harsh conditions, that is to say for example subjected to strong vibrations, or when they are subjected to numerous manipulations resulting in many inserts/removals of the female contact with the male contact, the female contact deforms and the electrical contact is then no longer assured continuously.

In addition, the female contacts integrated in electrical connections must have very precise measurements since their dimensioning is dependent in particular on the measurements of the corresponding male contact. However, very slight dimensioning variations may appear during the manufacture of the female contacts. This is why it is very important for the contact between the female contact and a male contact to be established continuously even if the female contacts do not have exactly the required measurements.

Consequently, it would be beneficial to provide a female contact making it possible to assure continuous electrical contact whatever the conditions of use (environment, duration, etc.) and even when slight dimensioning variations occur during the manufacturing process thereof or during use thereof.

The inventors have shown that a female contact comprising a spring would be able to satisfy these requirements.

The invention therefore firstly relates to a female contact intended to receive a male contact, said female contact comprising a base and at least one side wall having a free edge defining an open end, said side wall being connected to the base and comprising an inner wall, wherein:
the female contact comprises a helical spring made of an electrically conductive material disposed between the base and the open end,
part of the inner wall and the base are made of an electrically conductive material, and
the inner wall of the female contact and/or the spring assure/assures electrical contact with a male contact in the position of use, and
said helical spring comprises a lower part having a diameter d_{PI} and an upper part having a diameter d_{PS} with d_{PI}>d_{PS}, the lower part of the helical spring being oriented from the side of the base of the female contact and the upper part of the helical spring being oriented toward the free edge of the female contact.

In the context of the invention, the term “female contact” means any device making it possible to establish electrical contact when a male contact is inserted therein.

Hereinafter, the terms “female contact” and “socket” will be used synonymously.

In accordance with an embodiment, the female contact is a contact used in a connector such as a baseplate for an electrical relay. The female contact may be provided in the form of a socket having two lips or four lips.

In accordance with a particular embodiment of the invention, not only the inner wall of the side wall of the female contact but also the spring assure electrical contact with a male contact in the position of use, in order to maximize the points of contact between the female contact and a male contact.

In accordance with an embodiment of the invention the spring is in contact with the base of the female contact.

In accordance with an embodiment the base of the female contact is provided in the form of a conical cavity.

In accordance with another embodiment of the invention the base of the female contact is flat and is selected from the group consisting of a circular, oval, rectangular or square base.

In accordance with the invention the female contact comprises at least one side wall. The number of side walls will depend in particular on the shape of the base.

Examples include a female contact comprising a circular base and one side wall or a female contact comprising a square base and four side walls.

In accordance with the invention the coordinate system (X, Y, Z) is used in which the direction X is the longitudinal direction of the side wall.

In accordance with an embodiment the side wall has at least one interruption (also referred to as a slot) along the direction X.

In accordance with a particular embodiment the side wall has two diametrically opposed slots which extend substantially from the base to the open end of the female contact, thus creating two lips that can deform under mechanical load. In effect, in this embodiment, the two lips make it possible to pinch closed the open end of the female contact prior to the insertion of the male contact. When the male contact is inserted into the female contact in order to be brought into its position of use, the lips deform slightly, but maintain the pinching of the open end so as to promote the contact with the male contact in the female contact in the position of use.

Thus, in accordance with a particular embodiment, the female contact has resilient properties so as to be able to deform.

In addition, in accordance with the invention, at least part of the inner wall, the base and the spring are made of an electrically conductive material so as to be able to establish electrical contact between the female contact and a male contact.

This is why, in a particular embodiment, the female contact is produced using a material that is both resilient and electrically conductive, selected from the group consisting of copper alloys, such as beryllium copper, copper-nickel, brass, and mixtures thereof.

The spring of the invention may be provided in different forms, provided it deforms under the action of an external force thus making it possible to adapt to male contacts of different length.

In accordance with an embodiment the helical spring is provided in the form of a sequence of non-contiguous turns with a constant pitch, i.e. with a constant distance between two successive turns.

In accordance with an embodiment the helical spring has a pitch between 0.1 mm and 2 mm, preferably between 0.4 mm and 0.8 mm.

In accordance with an embodiment the helical spring has turns having a constant diameter dₛₚᵢᵣₑₛ between 0.2 mm and 1 mm, preferably between 0.3 mm and 0.5 mm.

In accordance with the invention the helical spring has a lower part having a diameter d_{PI} and an upper part having a diameter d_{PS} with d_{PI}>d_{PS}, the lower part of the helical spring being oriented on the side of the base of the female contact and the upper part of the helical spring being oriented toward the free edge of the female contact.

In accordance with another embodiment the female contact is tubular and has a base of inner diameter d_{b} and the ratio between the diameter d_{PI} of the spring and the inner diameter d_{b} of the base (d_{PI}/d_{b}) is substantially greater than 1.

The term “substantially greater than 1” means a maximum variation of 10% around the value 1.

Thus, in accordance with this embodiment, the spring is fixed integrally to the female contact, irrespective of the conditions of use.

The dimensions given, above, which are non-limiting, are given on the basis of a reference male contact having a length of 15.7 mm.

In accordance with an embodiment d_{PI} is between 1 and 3 mm, preferably between 1.4 and 1.7 mm.

In accordance with an embodiment d_{PS} is between 0.5 and 2.5 mm, preferably between 1.2 and 1.4 mm.

In accordance with an embodiment d_{b} is between 1 mm and 3.5 mm, preferably between 1.4 and 1.9 mm.

A person skilled in the art will know to find a suitable ratio between the length of the spring lᵣ and the length of the female contact l_{CF} on the basis of the dimensions of the male contact having to be inserted into the female contact.

In accordance with the invention the spring is made of a material having the two following combined features: from a mechanical viewpoint the spring must be resilient, and from an electrical viewpoint the spring must be conductive.

Thus, in accordance with an embodiment, the spring is made of a material selected from the group consisting of copper alloys, such as beryllium copper, copper-nickel, brass, and mixtures thereof.

In accordance with an embodiment the spring and the female contact are produced using the same material(s).

In order to improve the mechanical and electrical properties thereof, the material of the spring may be subjected to different treatments, such as heat treatments and/or surface treatments (for example gold deposition on the entire surface of the spring).

A person skilled in the art will know to choose suitable materials on the basis of the amperage that must pass through the female contact. By way of example, for a spring made of beryllium copper having a diameter dₛₚᵢᵣₑₛ of 0.4 mm, the amperage is approximately 5 amperes (5 A).

In accordance with the invention the female contact can be found in different connectors, such as baseplates for electrical relays or any conventional connections comprising connectors.

Thus, the invention also relates to a connector comprising at least one female contact as defined in accordance with the invention.

In accordance with an embodiment the female connector comprises between 12 and 24 female contacts.

The invention also relates to a kit comprising a connector comprising at least one female contact as defined in accordance with the invention and one male connector.

The invention also relates to a kit comprising a connector comprising at least one female contact, at least one spring as defined above, and one male connector.

The presence of the spring in the female contact of the invention makes it possible to establish reliable contact, irrespective of the conditions of use.

Thus, the invention also relates to the use of the female contact, of the female connector, or of the kits as defined in the present invention under conditions generating strong mechanical and/or thermal stresses, as might be encountered in transport means, such as aircraft or trains, etc.

The present invention also relates to a method for modifying a female connector intended to receive a male connector comprising the following steps:
(i) providing a female connector comprising at least one female contact intended to receive a male connector comprising at least one male contact, said female contact comprising a base and at least one side wall having a free edge defining an open end, the side wall comprising an inner wall and being connected to the base;
(ii) inserting a helical spring made of an electrically conductive material between the base and the open end of the female contact;
(iii) possibly inserting a male contact into the female contact modified in step (ii) so as to establish electrical contact via the inner wall of the female contact and/or via the spring,
characterized in that said helical spring comprises a lower part having a diameter d_{PI} and an upper part having a diameter d_{PS} with d_{PI}>d_{PS}, the lower part of the helical spring being oriented from the side of the base of the female contact and the upper part of the helical spring being oriented toward the free edge of the female contact.

Thus, the method of the invention makes it possible to use female contacts that do not have exactly the precise dimensions required in order to establish electrical contact with a male contact and/or makes it possible to increase the service life of a female contact which would have been deformed over time. In effect, the presence of the spring makes it possible to establish the electrical contact between the female contact and a male contact even if the male contact is not in direct contact with the side wall of the female contact.

The method of the invention also makes it possible to re-establish electrical contact in a faulty connector very quickly and very conveniently whilst avoiding removal of the electrical cables of the electrical device as a whole in which the female contact is integrated.

In accordance with an embodiment the spring is inserted into the female contact until the spring is in contact with the base of the female contact.

In accordance with another embodiment the spring is inserted by force into the female contact in order to assure that said spring is held in the female contact whatever the conditions of use.

In accordance with an embodiment the base of the female contact is provided in the form of a conical cavity.

In accordance with an embodiment of the invention the base of the female contact is flat and is selected from the group consisting of a circular, oval, rectangular, or square base.

In accordance with the invention the female contact comprises at least one side wall. The number of side walls will depend in particular on the shape of the base.

Examples include a female contact comprising a circular base and a side wall or a female contact comprising a square base and four side walls.

In accordance with the invention the coordinate system (X, Y, Z) is used in which the direction X is the longitudinal direction of the side wall.

In accordance with an embodiment the side wall has at least one interruption (also referred to as a slot) along the direction X.

In accordance with a particular embodiment the side wall has two diametrically opposed slots, which extend substantially from the base to the open end of the female contact, thus creating two lips that can deform under mechanical load. In effect, in this embodiment, the two lips make it possible to pinch closed the open end of the female contact prior to the insertion of the male contact. When the male contact is inserted into the female contact in order to be brought into its position of use, the lips deform slightly, but maintain the pinching of the open end so as to promote the contact with the male contact in the female contact in the position of use.

Thus, in accordance with a particular embodiment, the female contact has resilient properties so as to be able to deform.

In addition, in accordance with the invention, at least part of the inner wall, the base and the spring are made of an electrically conductive material so as to be able to establish electrical contact between the female contact and a male contact.

This is why, in a particular embodiment, the female contact is produced using a material that is both resilient and electrically conductive, selected from the group consisting of copper alloys, such as beryllium copper, copper-nickel, brass, and mixtures thereof.

The spring of the invention may be provided in different forms, provided it deforms under the action of an external force thus making it possible to adapt to male contacts of different length.

In accordance with an embodiment combined with the previous embodiment the helical spring is provided in the form of a sequence of non-contiguous turns with a constant pitch, i.e. with a constant distance between two successive turns.

In accordance with an embodiment the helical spring has a pitch between 0.1 mm and 2 mm, preferably between 0.4 mm and 0.8 mm.

In accordance with an embodiment the helical spring has turns having a constant diameter dₛₚᵢᵣₑₛ between 0.2 mm and 1 mm, preferably between 0.3 mm and 0.5 mm.

In accordance with the invention the helical spring has a lower part having a diameter d_{PI} and an upper part having a diameter d_{PS} with d_{PI}>d_{PS}, the lower part of the helical spring being oriented from the side of the base of the female contact and the upper part of the helical spring being oriented toward the free edge of the female contact.

In accordance with another embodiment the female contact is tubular and has a base of inner diameter d_{b} and the ratio between the diameter d_{PI} of the spring and the inner diameter d_{b} of the base (d_{PI}/d_{b}) is substantially greater than 1.

The term “substantially greater than 1” means a maximum variation of 10% around the value 1.

Thus, in accordance with this embodiment, the spring is fixed integrally to the female contact, irrespective of the conditions of use.

The dimensions given, above, which are non-limiting, are given on the basis of a reference male contact having a length of 15.7 mm.

In accordance with an embodiment d_{PI} is between 1 and 3 mm, preferably between 1.4 and 1.7 mm.

In accordance with an embodiment d_{PS} is between 0.5 and 2.5 mm, preferably between 1.2 and 1.4 mm.

In accordance with an embodiment d_{b} is between 1 mm and 3.5 mm, preferably between 1.4 and 1.9 mm.

A person skilled in the art will know to find a suitable ratio between the length of the spring lᵣ and the length of the female contact l_{CF} on the basis of the dimensions of the male contact having to be inserted into the female contact.

In accordance with the invention the spring is made of a material having the two following combined features: from a mechanical viewpoint the spring must be resilient, and from an electrical viewpoint the spring must be conductive.

Thus, in accordance with an embodiment the spring is made of a material selected from the group consisting of copper alloys, such as beryllium copper, copper-nickel, brass, and mixtures thereof.

The spring and the female contact are advantageously produced using the same material(s).

In order to improve the mechanical and electrical properties thereof, the material of the spring may be subjected to different treatments, such as heat treatments or surface treatments (for example gold deposition on the entire surface of the spring).

A person skilled in the art will know to choose suitable materials on the basis of the amperage that must pass through the female contact. By way of example, for a spring made of beryllium copper having a diameter dₛₚᵢᵣₑₛ of 0.4 mm, the amperage is approximately 5 amperes (5 A).

The invention will be described in greater detail hereinafter with the aid of the accompanying drawings, in which:

FIG. 1 shows partially in section a male contact inserted into a baseplate socket for an electrical relay of the prior art;

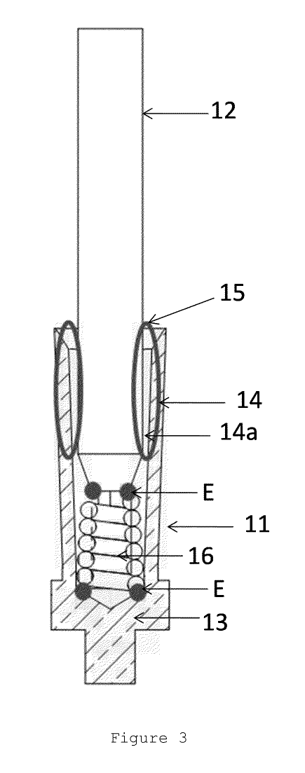

FIG. 2 shows the assembly of the male contact inserted into the socket of the baseplate for the electrical relay of FIG. 1 having undergone deformations following use in harsh conditions;

FIG. 3 shows a longitudinal section of a male contact inserted into a baseplate socket for an electrical relay according to the present invention;

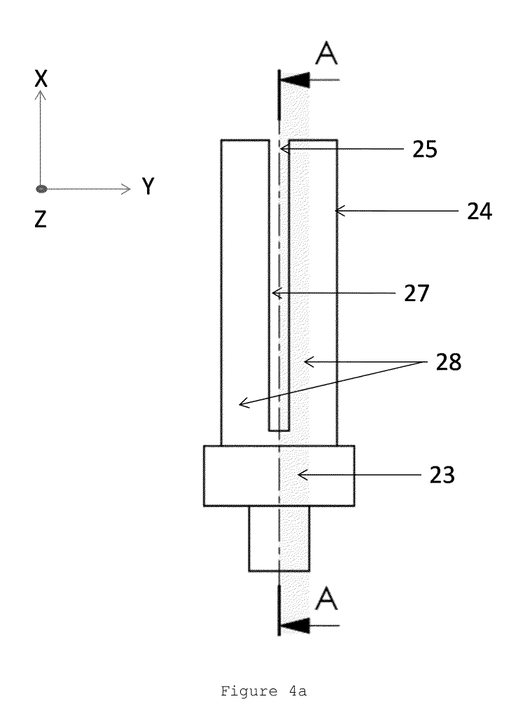

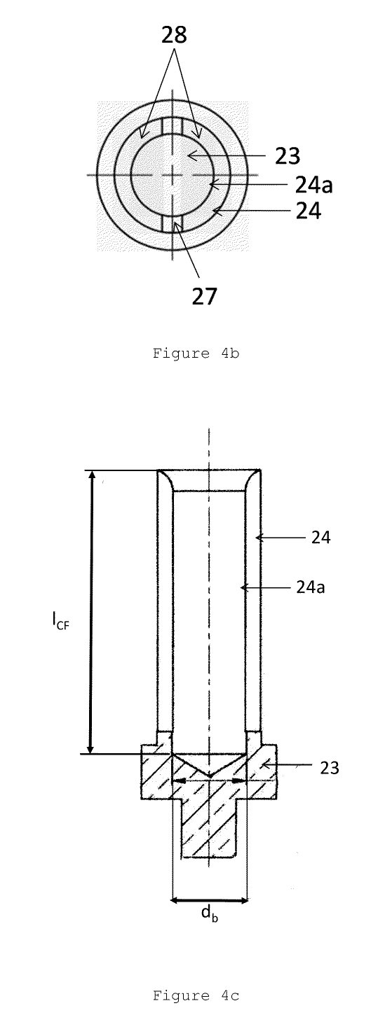

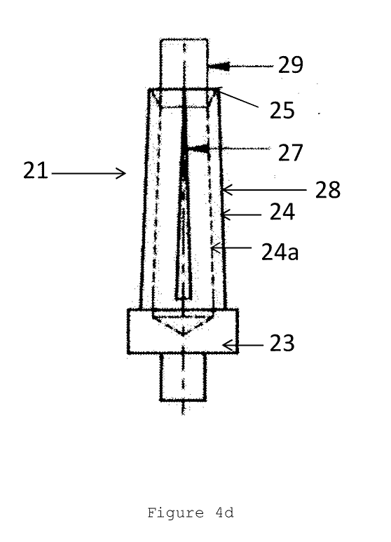

FIGS. 4a-4d schematically show a socket in accordance with an embodiment of the invention;

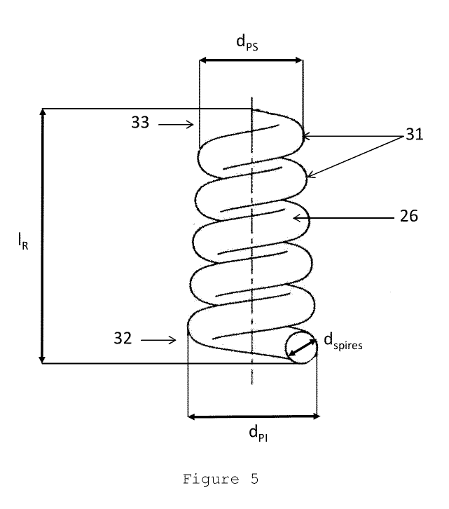

FIG. 5 schematically shows a spring comprised in a socket in accordance with an embodiment of the invention.

FIG. 1 illustrates the points of electrical contact between a female contact 1 (here a socket) and a male contact 2 in a baseplate for a conventional electrical relay.

The female contact 1 comprises a base 3, at least one side wall 4 being connected to the base 3 and comprising an inner wall 4a. The side wall 4 has a free edge defining an open end 5, into which the male contact 2 will be inserted in the position of use.

The electrical contact E (shown by round contact points in FIG. 1) is established by contact between the inner surface 4a of the side wall 4 of the female contact 1 and the male contact 2 in an upper part of the female contact (that is to say close to the open end 5).

However, as explained beforehand and as illustrated in an exaggerated manner with FIG. 2, when the baseplates for relays are used in harsh conditions, or when they are subjected to numerous manipulations, the upper part of the female contact 1 deforms and the electrical contact is no longer assured continuously.

By contrast with female contacts of the prior art, the female contact 11 of the present invention illustrated in FIG. 3 comprises a spring 16 disposed on the base 13 of said female contact. Thus, even if the electrical contact can no longer be established by contact between the inner surface 14a of the side wall 14 and the male contact 12, it is assured by the presence of the spring 16. In effect, as illustrated in FIG. 3, the points of contact E are located both between the male contact 12 and the spring 16 and between the spring 16 and the base 13 of the female contact 11.

The structure of the female contact is described below in further detail by way of FIGS. 4a to 4c.

FIG. 4a shows a side view of the female contact according to the invention. The female contact 21 comprises a circular base 23 (shown in FIG. 4b) and a side wall 24 connected to the base 23. The side wall comprises an inner wall 24a and a free edge defining an open end 25. The side wall 24 comprises two diametrically opposed slots 27 extending substantially from the base 23 to the open end 25 of the female contact 21 along the axis X, thus creating two lips 28.

FIG. 4b is a view from above of FIG. 4a showing that the female contact is provided in a tubular form and comprises a circular base 23 connected to a side wall 24 comprising two diametrically opposed slots 27.

FIG. 4c is a section along the axis A-A of FIG. 4a. In accordance with a particular embodiment the base 23 of the female contact 21 has an inner diameter d_{b} substantially smaller than the diameter of the lower part d_{PI} of the spring intended to be in contact with the base (not shown in FIG. 4c). The length l_{CF} of the female contact 21 will depend on the length of the male contact having to be inserted into the female contact. In accordance with an embodiment the length l_{CF} of the female contact 21 is between 3 and 10 mm, preferably between 5 and 8 mm.

In accordance with an embodiment the diameter d_{b} is between 1 and 3.5 mm, preferably between 1.4 and 1.9 mm.

FIG. 4d shows a side view of the female contact of FIGS. 4a and 4b after pinching of the two lips 28. As illustrated in FIG. 4d, the width of the slot 27 is no longer constant as in FIG. 4a, but reduces from the base 23 to the open end 25 until becoming practically zero.

Thus, when the male contact 29 (shown only in part in FIG. 4d) is inserted into the female contact 21, the lips 28 deform slightly, but maintain a pinching of the open end 25 so as to promote the contact with the male contact 29 in the female contact 21 in the position of use.

FIG. 5 shows a helical spring 26 in accordance with an embodiment of the invention. The helical spring 26 comprises a sequence of five non-contiguous turns 31 having a constant pitch.

The turns 31 have a constant diameter dₛₚᵢᵣₑₛ between 0.2 mm and 1 mm, preferably between 0.3 mm and 0.5 mm.

The helical spring 26 comprises a lower part 32 having a diameter d_{PI} and an upper part 33 having a diameter d_{PS} with d_{PI}>d_{PS}, the lower part 32 of the helical spring 25 being oriented from the side of the base 23 of the female contact and the upper part 33 of the helical spring 26 being oriented toward the open end 25 of the female contact.

Thus, the female contact of the present invention is quite suitable for integration in baseplates for electrical relays of small size requiring female contacts having very precise measurements.

In addition, the method of the invention makes it possible to establish electrical contact in connectors comprising contacts which do not have exactly the required measurements.

Lastly, the method of the invention makes it possible to extend the service life of electrical installations in which faulty connectors are integrated, by re-establishing the electrical contact and avoiding removal of all the cables of said electrical installations.

1-10. (canceled)

11- A female contact (11, 21) intended to receive a male contact (12, 29), said female contact (11, 21) comprising a base (13, 23) and at least one side wall (14, 24) having a free edge defining an open end (15, 25), said side wall (14, 24) being connected to the base (13, 23) and comprising an inner wall (14a, 24a), wherein:
the female contact (11, 21) comprises a helical spring (16, 26) made of an electrically conductive material disposed between the base (13, 23) and the open end (15,25),
part of the inner wall (14a, 24a) and the base (13, 23) are made of an electrically conductive material, and
the inner wall (14a, 24a) of the female contact (11, 21) and/or the spring (16, 26) assure/assures electrical contact with a male contact (12, 29) in the position of use,
wherein said helical spring (16, 26) comprises a lower part (32) having a diameter d_{PI} and an upper part (33) having a diameter d_{PS} with d_{PI}>d_{PS}, the lower part (32) of the helical spring being oriented from the side of the base (13, 23) of the female contact and the upper part (33) of the helical spring being oriented toward the free edge of the female contact.

12- The female contact (11, 21) as claimed in claim 11, wherein the spring (16, 26) is in contact with the base (13, 23) of the female contact.

13- The female contact (11, 21) as claimed in claim 11, wherein:
the female contact is tubular and has a base of inner diameter d_{b}; and
the ratio between the diameter d_{PI} and the inner diameter d_{b} is substantially greater than 1.

14- The female contact (11, 21) as claimed in claim 11, wherein the spring (16, 26) is made of a material selected from the group consisting of copper alloys.

15- The female contact (11, 21) as claimed in claim 11, wherein the side wall has two diametrically opposed slots extending substantially from the base to the open end of the female contact.

16- A female connector comprising at least one female contact (11, 21) as defined as claimed in claim 11.

17- A kit comprising the female connector as defined in claim 16 and a male connector.

18- A method for modifying a female connector intended to receive a male connector, comprising the following steps:
(i) providing a female connector comprising at least one female contact (11, 21) intended to receive a male connector comprising at least one male contact (12, 29), said female contact (11, 21) comprising a base (13, 23) and at least one side wall (14, 24) having a free edge defining an open end (15, 25), said side wall (14, 24) being connected to the base (13, 23) and comprising an inner wall (14a, 24a);
(ii) inserting a helical spring (16, 26) made of an electrically conductive material between the base (13, 23) and the open end (15, 25) of the female contact;
(iii) possibly inserting a male contact into the female contact modified in step (ii) so as to establish electrical contact via the inner wall (14a, 24a) of the female contact and/or via the spring;
wherein said helical spring (16, 26) comprises a lower part (32) having a diameter d_{PI} and an upper part (33) having a diameter d_{PS} with d_{PI}>d_{PS}, the lower part (32) of the helical spring being oriented from the side of the base (13, 23) of the female contact and the upper part (33) of the helical spring being oriented toward the free edge of the female contact.

19- The method as claimed in claim 18, wherein the spring is inserted until the spring (16, 26) is in contact with the base (13, 23) of the female contact.

20- The female contact (11, 21) as claimed in claim 14, wherein copper alloys are beryllium copper, copper-nickel, brass, and mixtures thereof.
